(19) United States
(12) Patent Application Publication
(10) Pub. No.: US 2016/0096983 A1
(43) Pub. Date: Apr. 7, 2016

(54) METHOD FOR PRODUCING HOT MELT ADHESIVES CONTAINING SILANE GROUPS

(71) Applicant: SIKA TECHNOLOGY AG, Baar (CH)

(72) Inventors: Urs BURCKHARDT, Zürich (CH); Andreas KRAMER, Zürich (CH)

(21) Appl. No.: 14/890,199

(22) PCT Filed: Nov. 25, 2013
(86) PCT No.: PCT/EP2013/074600

§ 371 Date: Nov. 10, 2015

(30) Foreign Application Priority Data
May 22, 2013 (EP) 13168806.1

(51) Int. Cl. C09J 175/06

(52) U.S. Cl. CPC C09J 175/06

(57) ABSTRACT

A method for producing a hot melt adhesive containing silane groups, in which at least one polyurethane polymer which contains isocyanate groups and is solid at room temperature is reacted with at least one hydroxysilane that is devoid of urea and thiourethane groups. The hot melt adhesive containing silane groups obtained from the method allows a low hazard classification, has a good degree of thermal resistance when melted such that, even upon application under prolonged heating, it does not tend towards premature thickening, releases no unpleasant odours, and crosslinks at room temperature without bubbles under the influence of moisture, resulting in an optically and mechanically high-quality and resistant adhesive connection.

### TECHNICAL FIELD

The invention relates to moisture-crosslinking hotmelt adhesives.

### PRIOR ART

Hotmelt adhesives (hotmelts) are polymer compositions which are solid at room temperature and which for the purpose of application are melted and applied while hot to the substrates where bonding is to take place, these substrates being joined immediately thereafter. Following its application, the hotmelt adhesive, usually applied as a thin film, undergoes rapid cooling, with the bond very rapidly developing strength as a result.

Conventional hotmelt adhesives are chemically unreactive and remain thermoplastic after application. As a consequence of this they are unsuitable for bonds exposed to elevated temperature. Moreover, they often also exhibit creep (cold flow) at temperatures far below the softening point.

These disadvantages have been largely eliminated with what are called reactive hotmelt adhesives, comprising reactive groups which lead to the crosslinking of the adhesive polymers by means of moisture. As a result of the cooling, the early strength typical of hotmelt adhesives is developed first of all, following by crosslinking of the polymers through chemical reaction, which takes place typically at room temperature and may take a number of hours to several days. Following crosslinking, the bond can be heated without the adhesive melting. The chemical crosslinking of the adhesive means that the cold flow is prevented as well.

Polyurethane hotmelt adhesives, especially those containing isocyanate groups are widely used. A disadvantage of these systems is that they tend to form blisters on crosslinking, particularly in the case of amorphous polymers and in conditions of increased moisture or temperature. The blisters may severely detract from the aesthetic and mechanical quality and also from the stability of the bond. A further disadvantage is the presence therein of airway-irritant monomeric isocyanates, which may outgas during application and may necessitate protective measures. This results in a higher hazard classification for the products, thereby restricting their usefulness.

Instead of systems containing isocyanate groups, it is possible to use silane group-containing systems (“STP hotmelt adhesives”). These adhesives crosslink by way of the condensation reaction of silanol groups, which form from the silane groups by hydrolysis, and allow a low hazard classification because of the low monomeric isocyanate content. The silane groups are most easily introduced by reaction of an isocyanate group-containing polyurethane hotmelt adhesive with an aminosilane or a mercaptosilane, as described for example in EP 0 202 491 and EP 1 801 138. These systems known from the prior art, however, have disadvantages. On prolonged heating during application, STP hotmelt adhesives prepared by way of aminosilanes may abruptly thicken up severely and so become impossible to apply. This is a great disadvantage especially for applications in industrial manufacture where the adhesive spends a certain time in the melted state at the application temperature. While STP hotmelt adhesives prepared by way of mercaptosilanes do not thicken up in the melted state, they do have the disadvantage that the attachment of the silane group, especially at elevated temperature, is reversible and hence on application there is release of intensely odorous mercapto compounds, a highly undesirable phenomenon. EP 0 354 472 describes STP hotmelt adhesives obtained using isocyanatosilanes. The isocyanatosilanes used are obtained from mercapto- or aminosilanes by reaction with diisocyanates and dialcohols. In this process the silane groups are likewise bonded to the polymer via urea and/or thiourethane groups, meaning that the difficulties identified above continue to exist.

### DESCRIPTION OF THE INVENTION

It is an object of the present invention, therefore, to provide a method for producing a silane group-containing hotmelt adhesive that permits a low hazard classification and exhibits high thermal stability in the melted state, in other words exhibiting no tendency toward premature thickening and giving off no unpleasant odors.

Surprisingly it has been found that the method of claim 1 achieves this object. It involves reacting a hydroxysilane which is free from urea groups and from thiourethane groups with an isocyanate group-containing polyurethane polymer which is solid at room temperature. The silane group-containing hotmelt adhesive obtainable by the method of the invention permits a low hazard classification since, depending on the stoichiometry deployed, it has a low or zero monomeric isocyanate content. Even on sustained heating, during the duration of the application procedure, it exhibits high thermal stability and shows no tendency toward premature thickening; as a result, it is easy to apply, without causing any emissions, since the silane groups are attached largely irreversibly. Lastly, it undergoes blister-free crosslinking at room temperature under the influence of moisture, and results in an optically and mechanically high-grade and robust adhesively bonded assembly.

The preparation and handling of hydroxysilanes carries the difficulty that the silanes tend toward self-condensation, owing to a rapid reaction of the hydroxyl group with the silane group, and are therefore frequently highly impure and/or of low storage stability. In particular, however, the preferred hydroxysilanes having a secondary hydroxyl group are surprisingly stable enough to enable access thereby to silane group-containing hotmelt adhesives with high strength.

Further aspects of the invention are subjects of further independent claims. Particularly preferred embodiments of the invention are subjects of the dependent claims.

### Ways of Implementing the Invention

A subject of the invention is a method for producing a silane group-containing hotmelt adhesive by reacting at least one isocyanate group-containing polyurethane polymer which is solid at room temperature with at least one hydroxysilane which is free from urea groups and from thiourethane groups.

In the present document, the term “silane” or “organosilane” refers to silicon compounds which on the one hand have at least one, customarily two or three, hydrolyzable substituents bonded directly to the silicon atom via Si—O bonds, and on the other hand have at least one organic radical bonded directly to the silicon atom via an Si—C bond. The hydrolyzable substituents here represent, in particular, alkoxy, acetoxy, ketoximato, amido, or enoxy radicals.

A “silane group” is the silicon-containing group bonded to the organic radical of a silane.

A “hydroxysilane”, “aminosilane”, “isocyanatosilane”, and the like are organosilanes which have a corresponding functional group on the organic radical, i.e., a hydroxyl group, amino group, or isocyanate group.

Substance names beginning with “poly”, such as polyol or polyisocyanate, denote substances which in formal terms include two or more per molecule of the functional groups that occur in their name.

The term “polyurethane polymer” encompasses all polymers which are prepared by the diisocyanate polyaddition process. The term “polyurethane polymer” also encompasses polyurethane polymers containing isocyanate groups, of the kind which are obtainable from the reaction of polyisocyanates and polyols and which themselves constitute polyisocyanates and are often also called prepolymers.

“Active hydrogen” refers to the hydrogen atoms of hydroxyl, mercapto, and primary and secondary amino groups.

“Molecular weight” is understood in the present document to be the molar mass (in grams per mole) of a molecule. “Average molecular weight” means the number average Mₙ of an oligomeric or polymeric mixture of molecules, and is customarily determined by GPC using polystyrene as a standard.

A dashed line in the formulae in this document represents in each case the bond between a substituent and the associated remainder of the molecule.

A “primary hydroxyl group” is an OH group which is bonded to a C atom having two hydrogens; a “secondary hydroxyl group” is an OH group which is bonded to a C atom with one hydrogen.

The term “storage-stable” denotes the capacity of a substance or of a composition to be storable at room temperature in a suitable container for a number of weeks up to 6 months or more, without changing in its application or service properties to an extent relevant for its use, as a result of such storage. “Room temperature” refers to a temperature of about 23° C.

The reaction of the isocyanate group-containing polyurethane polymer which is solid at room temperature with the hydroxysilane is carried out advantageously with exclusion of moisture and at an elevated temperature, more particularly at a temperature at which the polyurethane polymer is in liquid form. The reaction is accomplished preferably by the isocyanate group-containing polyurethane polymer and the hydroxysilane being reacted at a temperature in the range from 60 to 180° C., more particularly 80 to 160° C., with hydroxyl groups of the hydroxysilane undergoing reaction with isocyanate groups present to form urethane groups. As a result, the silane groups are bonded covalently to the polyurethane polymer. A catalyst can be used here, more particularly a bismuth(III), zinc(II), zirconium(IV), or tin(II) compound or an organotin(IV) compound.

The attachment of the silane groups via urethane groups has the great advantage here that the hotmelt adhesive obtained exhibits very good thermal stability both in the noncrosslinked state and in the crosslinked state. This thermal stability on the part of the noncrosslinked adhesive is important for its good applicability. Hotmelt adhesives whose silane groups are bonded to the polymer via urea groups or thiourethane groups exhibit weaknesses in this respect. The thiourethane group in particular is easily splittable by heat, releasing sulfur-containing substances which lead to instances of odor pollution. In the case of urea groups as well, an instability is observed which leads—presumably as a result of catalytic processes—to severe thickening or even gelling of the adhesive in the melted state.

One embodiment of the invention uses the polyurethane polymer and the hydroxysilane in an amount such that the OH groups of the hydroxysilane are present substoichiometrically in relation to the isocyanate groups of the polyurethane polymer, meaning that the OH/NCO ratio is less than 1. This reaction produces a silane group-containing hotmelt adhesive which additionally has isocyanate groups. In a hotmelt adhesive of this kind, both the silane groups and the isocyanate groups contribute to crosslinking under the influence of moisture. A hotmelt adhesive of this kind has a significantly reduced monomeric isocyanate content by comparison with the isocyanate group-containing polyurethane polymer used for the method described. An OH/NCO ratio in the range from 0.1 to 0.9 is preferred, 0.2 to 0.8 particularly preferred, and 0.3 to 0.7 more particularly. A hotmelt adhesive of this kind has in particular a monomeric isocyanate content of <2 weight %, more particularly <1 weight %. Because of labeling regulations, a hotmelt adhesive of this kind has, in particular, a monomeric MDI content of <1 weight %, or a monomeric IPDI content of <2 weight %, more particularly <0.5 weight %, with the abbreviation “MDI” representing “4,4′-, 2,4′- and/or 2,2′-diphenylmethane diisocyanate and any desired mixtures of these isomers” and the abbreviation “IPDI” representing “isophorone diisocyanate”.

A preferred embodiment of the invention uses the polyurethane polymer and the hydroxysilane in an amount such that the OH groups of the hydroxysilane are present at least stoichiometrically in relation to the isocyanate groups of the polyurethane polymer, meaning that the OH/NCO ratio is at least 1. This reaction produces a silane group-containing hotmelt adhesive which is free from isocyanate groups. An isocyanate group-free hotmelt adhesive of this kind is particularly advantageous from a toxicological standpoint. An isocyanate group-free hotmelt adhesive, correspondingly, is also free from monomeric isocyanates. A preferred OH/NCO ratio is in the range from 1 to 2, more preferably 1 to 1.8, more particularly 1 to 1.5.

The method described uses at least one isocyanate group-containing polyurethane polymer which is solid at room temperature. At room temperature it may be crystalline, semicrystalline, or amorphous. For a semicrystalline or amorphous polyurethane polymer the rule is that it has only little or no fluidity at room temperature. This means in particular that its viscosity at 20° C. is more than 5000 Pa·s.

The isocyanate group-containing polyurethane polymer preferably has an average molecular weight Mₙ in the range from 2000 to 20 000 g/mol, preferably 2000 to 15 000 g/mol, more particularly 2000 to 10 000 g/mol.

The isocyanate group-containing polyurethane polymer preferably has 1 to 3, more preferably 2, isocyanate groups per molecule.

A polyurethane polymer of this kind permits a suitable processing viscosity and good mechanical properties in the crosslinked state.

A suitable isocyanate group-containing polyurethane polymer which is solid at room temperature is obtained in particular through the reaction of at least one polyol with at least one diisocyanate, the diisocyanate being present in a stoichiometric excess.

A preferred ratio between isocyanate groups and hydroxyl groups is in the range from 1.5 to 5, more preferably 1.8 to 4, more particularly 2 to 3.

The reaction is carried out advantageously at elevated temperature, more particularly at a temperature at which the polyols and diisocyanates used and the polyurethane polymer formed are in liquid form. A suitable catalyst is optionally present.

In the reaction of polyols with diisocyanates to give an isocyanate group-containing polyurethane polymer, the statistical distribution of the possible reaction products means that a residual amount of unreacted monomeric diisocyanates remains in the polymer formed. These monomeric diisocyanates, also called “monomeric isocyanates” for short, are volatile compounds and may be harmful to health on account of their irritant, allergenic and/or toxic effect.

Suitable polyol comprises, in particular, polyols which are solid at room temperature.

Particularly suitable are polyols which are amorphous or semicrystalline or crystalline at room temperature, more particularly polyester polyols and polycarbonate polyols.

Especially suitable polyester polyols are those prepared from di- to trihydric, preferably dihydric, alcohols, such as, in particular, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane, or mixtures of the aforesaid alcohols, with organic dicarboxylic acids or anhydrides or esters thereof, such as, in particular, succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid, or mixtures of the aforesaid acids, and also polyester polyols from lactones such as, for example, from ε-caprolactone.

Particularly suitable polyester polyols are polyester polyols formed from adipic acid, sebacic acid, or dodecanedicarboxylic acid as dicarboxylic acid and from hexanediol or neopentyl glycol as dihydric alcohol. The polyester polyols preferably have an average molecular weight Mₙ in the range from 1500 to 15 000 g/mol, preferably 1500 to 8000 g/mol, more particularly 2000 to 5500 g/mol.

Particularly suitable crystalline or semicrystalline polyester polyols are adipic acid/hexanediol polyesters and dodecanedicarboxylic acid/hexanediol polyesters.

Suitable polycarbonate polyols are those as obtainable in particular through reaction of the abovementioned alcohols—those used to synthesize the polyester polyols—with dialkyl carbonates, diaryl carbonates, or phosgene.

Preferred as polyol is a mixture of at least one amorphous polyester diol and at least one further polyester diol.

Particularly preferred as polyol are mixtures of amorphous and/or crystalline and/or semicrystalline polyester diols. With more particular preference the polyol is a mixture of an amorphous polyester diol and a polyester diol which is liquid at room temperature. In this way it is possible, for example, to produce transparent adhesives.

Likewise preferably the polyol is a crystalline or a semicrystalline polyester diol. Suitable diisocyanate comprises, in particular, commercially available aliphatic, cycloaliphatic, arylaliphatic, and aromatic, preferably cycloaliphatic and aromatic, diisocyanates.

Preferred diisocyanates are 1,6-hexamethylene diisocyanate (HDI), 2,2,4- and 2,4,4-trimethyl-1,6-hexamethylene diisocyanate (TMDI), cyclohexane-1,3- and 1,4-diisocyanate and any desired mixtures of these isomers, 1-isocyanato-3,3,5-trimethyl-5-isocyanatomethylcyclohexane (i.e., isophorone diisocyanate or IPDI), perhydro-2,4′- and -4,4′-diphenylmethane diisocyanate (HMDI), m- and p-xylylene diisocyanate (m- and p-XDI), m- and p-tetramethyl-1,3- and -1,4-xylylene diisocyanate (m- and p-TMXDI), 2,4- and 2,6-tolylene diisocyanate (TDI) and any desired mixtures of these isomers, and 4,4′-, 2,4′-, and 2,2′-diphenylmethane diisocyanate and any desired mixtures of these isomers (MDI).

More preferably the diisocyanate is selected from the group consisting of IPDI, MDI, and TDI. These diisocyanates are particularly easily obtainable.

Preferred among these is MDI. Hotmelt adhesives based thereon have particularly good mechanical properties and rapid crosslinking.

Further preferred among these is IPDI. Hotmelt adhesives based thereon have particularly good light stability and stability with respect to discoloration. This is advantageous especially for the bonding of transparent substrates.

The method described also uses at least one hydroxysilane which is free from urea groups and from thiourethane groups.

The difficulty in preparing and storing hydroxysilanes is basically that a hydroxyl group can react with a silane group and, in so doing, release a hydrolyzable group (“self-condensation”). In principle this is possible both intra- and inter-molecularly, with either cyclic silanes or more highly condensed or oligomeric silane compounds having a plurality of silicon atoms being formed. Such impurities may form even during the preparation of hydroxysilanes, or during storage.

The hydroxysilane preferably has two or three hydrolyzable substituents on the silicon atom, preferably two or three alkoxy groups, more particularly ethoxy or methoxy groups. With particular preference the hydroxysilane has two or three, more particularly three, ethoxy groups. Hydroxysilanes having ethoxy groups are particularly stable with respect to self-condensation.

The hydroxysilane is preferably a hydroxysilane which comprises a secondary hydroxyl group. These hydroxysilanes, surprisingly, are sufficiently stable to produce silane group-containing hotmelt adhesives with high strength.

The method of the invention uses more particularly a hydroxysilane of the formula (I),

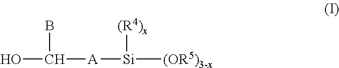

where
A either is a divalent aliphatic or cycloaliphatic hydrocarbon radical having 2 to 30 C atoms, optionally with aromatic fractions and optionally with one or more heteroatoms, which is free from active hydrogen,
   or together with B—CH is a divalent cycloaliphatic hydrocarbon radical having 6 to 20 C atoms, optionally with aromatic fractions and optionally with one or more heteroatoms, which is free from active hydrogen;
B is a monovalent aliphatic or cycloaliphatic hydrocarbon radical having 1 to 12 C atoms, optionally with one or more heteroatoms, which is free from active hydrogen,
   or together with CH-A is a divalent cycloaliphatic hydrocarbon radical having 6 to 20 C atoms, optionally with one or more heteroatoms, which is free from active hydrogen;
R⁴ is an alkyl group having 1 to 8 C atoms;
R⁵ is an alkyl group having 1 to 10 C atoms, optionally with one or more ether oxygens; and
x is 0 or 1 or 2.

The hydroxysilane of the formula (I) has a secondary hydroxyl group and is particularly advantageous in the use according to the invention, since it is preparable in high purity and exhibits high storage stability, and so permits very neat functionalization of the isocyanate group-containing polyurethane polymer with silane groups,—consequently, a silane group-containing hotmelt adhesive with high strength is obtainable.

Preferably, A either is a divalent aliphatic or cycloaliphatic hydrocarbon radical having 4 to 30 C atoms, which optionally comprises ether oxygen, a tertiary amino group, an amido group, or a urethane group, or together with B—CH is a divalent cycloaliphatic hydrocarbon radical having 6 to 20 C atoms, which optionally comprises ether groups and/or tertiary amino groups.

Preferably, B is an alkyl group having 1 to 12 C atoms, which optionally comprises ether groups and/or tertiary amino groups, or together with CH-A is a divalent cycloaliphatic hydrocarbon radical having 6 to 20 C atoms, which optionally comprises ether groups and/or tertiary amino groups.

R⁴ is preferably an alkyl group having 1 to 4 C atoms, more particularly methyl.

R⁵ is preferably an alkyl group having 1 to 4 C atoms, more particularly methyl or ethyl.

Hydroxysilanes with these preferred radicals A, B, R⁴, and R⁵ are particularly readily available.

R⁵ more particularly is a methyl group. Accordingly, silane group-containing hotmelt adhesives exhibiting particularly rapid moisture crosslinking are obtainable.

R⁵, moreover, is in particular an ethyl group. Obtainable accordingly are silane group-containing hotmelt adhesives which do not give off methanol on moisture crosslinking, something which is advantageous on grounds of toxicology. Preferably, x is 1 or 0, more particularly. With these hydroxysilanes, hotmelt adhesives are obtainable which crosslink particularly quickly on contact with moisture and exhibit particularly good mechanical properties.

The hydroxysilane of the formula (I) is preferably a hydroxysilane which has not been obtained from the addition reaction of an amino silane with a methyl-substituted cyclic carbonate, such as propylene carbonate in particular. This addition reaction is not very selective, meaning that as well as the hydroxysilane with secondary OH group, the reaction product includes a relatively high level of hydroxysilane with primary OH group. As a result, laborious purification of the reaction product is necessary and/or the storage stability and purity of the silane are greatly reduced, meaning that the strength of the resulting hotmelt adhesive in the crosslinked state is no more than moderate.

A suitable hydroxysilane of the formula (I) is a hydroxysilane which has a tertiary amino group. Hydroxysilanes of this kind are obtainable in particular from the reaction of at least one epoxy silane with at least one secondary amine. A hydroxysilane having a tertiary amino group is especially suitable for reaction with a polyurethane polymer based on aliphatic isocyanates, more particularly IPDI. Hotmelt adhesives derived therefrom exhibit high thermal stability in the noncrosslinked state, and good light stability.

A preferred hydroxysilane with a tertiary amino group is a hydroxysilane of the formula (I a),

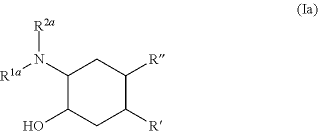

where
either R′ is a radical of the formula (II) and R″ is hydrogen
or R′ is hydrogen and R″ is a radical of the formula (II);

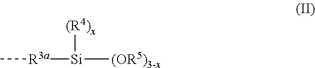

R^{1a} and R^{2a} either individually are each an alkyl radical having 1 to 12 C atoms, which optionally has heteroatoms in the form of ether oxygen, thioether sulfur, or tertiary amine nitrogen, or together are an alkylene radical having 2 to 12 C atoms which optionally has heteroatoms in the form of ether oxygen, thioether sulfur, or tertiary amine nitrogen;
R^{3a} is a linear or branched alkylene or cycloalkylene radical having 1 to 20 C atoms, optionally with aromatic fractions, and optionally with one or more heteroatoms;
and R⁴, R⁵, and x have the definitions already stated.

The hydroxysilane of the formula (I a) corresponds either to the formula (I a′) or to the formula (I a″).

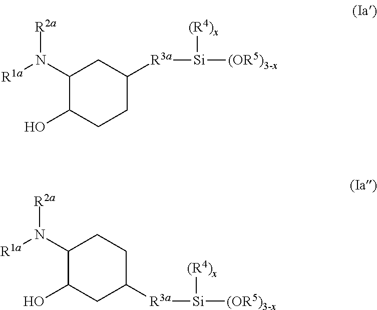

In the formulae (I a′) and (I a″), R^{1a}, R^{2a}, R^{3a}, R⁴, R⁵, ad x have the definitions already stated.

The formulae (I a′) and (I a″) encompass all diastereomers possible for the structure in question.

R^{1a} and R^{2a} preferably
either individually are each an alkyl radical having 3 to 10 C atoms which optionally has one or two ether oxygens,
or together are an alkylene radical having 4 to 8 C atoms which in particular has a heteroatom in the form of ether oxygen, thioether sulfur, or tertiary amine nitrogen and with inclusion of the nitrogen atom form a 5- or 6- or 7-membered ring, more particularly a 5- or 6-membered ring.
   R^{1a} and R^{2a} more preferably
either individually are 2-methoxyethyl, 2-ethoxyethyl, 3-methoxypropyl, 3-ethoxypropyl, 2-(2-methoxyethoxy)ethyl, 2-octyloxyethyl, ethyl, propyl, isopropyl, butyl, isobutyl, sec-butyl, 2-ethylhexyl, or N,N-dimethylamino-propyl,
or together, with inclusion of the nitrogen atom, are an optionally substituted pyrrolidine, piperidine, hexamethyleneimine, morpholine, thiomorpholine, or 4-methylpiperazine ring.

Very preferably R^{1a} and R^{2a} are each individually 2-methoxyethyl, butyl, or isopropyl, or together, with inclusion of the nitrogen atom, are morpholine, 2,6-dimethylmorpholine, thiomorpholine, pyrrolidine, or 4-methylpiperazine.

Most preferably R^{1a} and R^{2a} with inclusion of the nitrogen atom are morpholine or pyrrolidine.

These hydroxysilanes can be prepared in a particularly pure quality, and are particularly storage-stable. They enable silane group-containing hotmelt adhesives of high strength.

R^{3a} is preferably a linear or branched alkylene radical having 1 to 6 C atoms, more preferably a 1,2-ethylene radical.

A preferred hydroxysilane of the formula (I a) is in particular selected from the group consisting of 2-bis(2-methoxyethyl)amino-4-(2-triethoxysilylethyl)cyclohexan-1-ol, 2-dibutylamino-4-(2-triethoxysilylethyl)cyclohexan-1-ol, 2-diisopropylamino-4-(2-triethoxysilylethyl)cyclohexan-1-ol, 2-morpholino-4-(2-triethoxysilylethyl)cyclohexan-1-ol, 2-(2,6-dimethylmorpholino)-4-(2-triethoxy-silylethyl)cyclohexan-1-ol, 2-thiomorpholino-4-(2-triethoxysilylethyl)cyclohexan-1-ol, 2-pyrrolidino-4-(2-triethoxysilylethyl)cyclohexan-1-ol, 2-(4-methylpiperazino)-4-(2-triethoxysilylethyl)cyclohexa-1-ol, and the corresponding compounds in which the silane radical is in position 5 rather than in position 4, and the corresponding compounds with methoxy groups instead of ethoxy groups on the silane.

Preferred among these are 2-morpholino-4-(2-trimethoxysilylethyl)cyclohexan-1-ol, 2-morpholino-4-(2-triethoxysilylethyl)cyclohexan-1-ol, 2-pyrrolidino-4-(2-trimethoxysilylethyl)cyclohexan-1-ol, 2-pyrrolidino-4-(2-triethoxysilylethyl)cyclohexan-1-ol, and the corresponding compounds in which the silane radical is in position 5 rather than in position 4.

With these hydroxysilanes, silane group-containing hotmelt adhesives are obtained that have good processing viscosity and good storage stability, and which cure rapidly with moisture to form crosslinked adhesives of high strength. Particularly preferred in each case is a mixture of the two molecules in which the silane radical is present in positions 4 and 5. Such mixtures are also represented by the notation “4(5)”.

A hydroxysilane of the formula (I a) is preferably reacted with a polyurethane polymer having aliphatic isocyanate groups. The hotmelt adhesives obtained accordingly exhibit high thermal stability in the noncrosslinked state, and good light stability.

A further preferred hydroxysilane with a tertiary amino group is a hydroxysilane of the formula (I b),

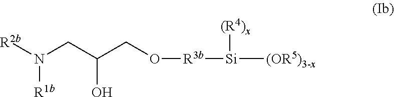

where
R^{1b} and R^{2b} either individually are each an alkyl radical having 1 to 12 C atoms, which optionally has heteroatoms in the form of ether oxygen, thioether sulfur, or tertiary amine nitrogen, or together are an alkylene radical having 2 to 12 C atoms which optionally has heteroatoms in the form of ether oxygen, thioether sulfur, or tertiary amine nitrogen;
R^{3b} is a linear or branched alkylene or cycloalkylene radical having 1 to 20 C atoms, optionally with aromatic fractions, and optionally with one or more heteroatoms;
and R⁴, R⁵, and x have the definitions already stated.
   R^{1b} and R^{2b} preferably
   either individually are each an alkyl radical having 3 to 10 C atoms which optionally has one or two ether oxygens,
   or together are an alkylene radical having 4 to 8 C atoms which in particular has a heteroatom in the form of ether oxygen, thioether sulfur, or tertiary amine nitrogen and with inclusion of the nitrogen atom form a 5- or 6- or 7-membered ring, more particularly a 5- or 6-membered ring.
      R^{1b} and R^{2b} more preferably
   either individually are 2-methoxyethyl, 2-ethoxyethyl, 3-methoxypropyl, 3-ethoxypropyl, 2-(2-methoxyethoxy)ethyl, 2-octyloxyethyl, ethyl, propyl, isopropyl, butyl, isobutyl, sec-butyl, 2-ethylhexyl, or N,N-dimethylamino-propyl,
   or together, with inclusion of the nitrogen atom, are an optionally substituted pyrrolidine, piperidine, hexamethyleneimine, morpholine, thiomorpholine, or 4-methylpiperazine ring.

Very preferably R^{1b} and R^{2b} are each individually 2-methoxyethyl, butyl, or isopropyl, or together, with inclusion of the nitrogen atom, are morpholine, 2,6-dimethylmorpholine, thiomorpholine, pyrrolidine, or 4-methylpiperazine.

Most preferably R^{1b} and R^{2b} With inclusion of the nitrogen atom are morpholine or pyrrolidine.

These hydroxysilanes can be prepared in a particularly pure quality, and are particularly storage-stable. They enable silane group-containing hotmelt adhesives of high strength.

R^{3b} is preferably a linear or branched alkylene radical having 1 to 6 C atoms, more particularly a 1,3-propylene radical. These hydroxysilanes are particularly readily available.

A preferred hydroxysilane of the formula (I b) is, in particular, selected from the group consisting of 1-morpholino-3-(3-(triethoxysilyl)propoxy)propan-2-ol, 1-(2,6-dimethylmorpholino)-3-(3-(triethoxysilyl)propoxy)propan-2-ol, bis(2-methoxyethyl)amino-3-(3-(triethoxysilyl)propoxy)propan-2-ol, 1-pyrrolidino-3-(3-(triethoxysilyl)propoxy)propan-2-ol, 1-piperidino-3-(3-(triethoxysilyl)propoxy) propan-2-ol, 1-(2-methylpiperidino)-3-(3-(triethoxysilyl)propoxy)propan-2-ol, dibutylamino-3-(3-(triethoxysilyl)propoxy)propan-2-ol, diisopropylamino-3-(3-(triethoxysilyl)propoxy)propan-2-ol, and the corresponding compounds with methoxy groups instead of ethoxy groups on the silane.

Preferred among these is 1-morpholino-3-(3-(triethoxysilyl)propoxy)propan-2-ol.

With these hydroxysilanes, silane group-containing hotmelt adhesives are obtained that have good processing viscosity and good storage stability, and which cure rapidly with moisture to form crosslinked adhesives having good mechanical properties.

A hydroxysilane of the formula (I b) is preferably reacted with a polyurethane polymer having aliphatic isocyanate groups. The hotmelt adhesives obtained accordingly exhibit high thermal stability in the noncrosslinked state, and good light stability.

A further suitable hydroxysilane of the formula (I) is a hydroxysilane which is free from tertiary amino groups. These hydroxysilanes are particularly suitable for reaction with a polyurethane polymer based on highly reactive aromatic isocyanates, especially MDI. Hotmelt adhesives derived therefrom exhibit high thermal stability in the noncrosslinked state, and particularly good mechanical properties.

In one embodiment, a hydroxysilane of this kind is a hydroxysilane with a urethane group. Such a hydroxysilane is obtained in particular from the reaction of at least one isocyanatosilane with at least one diol, more particularly a diol having at least one secondary hydroxyl group. Particularly suitable are reaction products of isocyanatosilanes such as 3-isocyanatopropyl-triethoxysilane and diols such as 1,2- or 1,3-butanediol, 1,2-pentanediol, 1,2-hexanediol, 1,2-octanediol, 2-ethyl-1,3-hexanediol, or 2,2,4-trimethyl-1,3-pentanediol, in a molar ratio of approximately 1:1.

A suitable hydroxysilane of the formula (I) which is free from tertiary amino groups is, moreover, a hydroxysilane with an amido group. A hydroxysilane of this kind is obtained in particular from the reaction of at least one aminosilane with at least one lactone, more particularly with a lactone substituted in alpha-position to the ring oxygen.

A preferred hydroxysilane with an amido group is a hydroxysilane of the formula (I c),

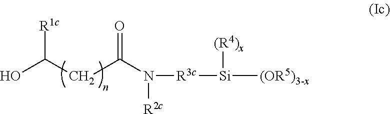

where
R^{1c} is an alkyl group having 1 to 12 C atoms;
R^{2c} is a hydrogen atom or is an alkyl group having 1 to 12 C atoms which optionally has ether oxygen or amine nitrogen;
R^{3c} is a linear or branched alkylene or cycloalkylene radical having 1 to 20 C atoms, optionally with aromatic fractions, and optionally with one or more heteroatoms; and
n is 2 or 3 or 4;
and R⁴, R⁵, and x have the definitions already stated.

R^{1c} is preferably a linear alkyl group having 1 to 8 C atoms, more particularly methyl, n-butyl, n-pentyl, n-hexyl, n-heptyl, or n-octyl.

R^{2c} is preferably a hydrogen atom.

Preferably n is 2 or 3, more particularly 2.

These hydroxysilanes are preparable in particularly pure quality and are particularly storage-stable. They permit silane group-containing hotmelt adhesives of high strength with particularly high thermal stability in the noncrosslinked state, including, in particular, those based on aromatic isocyanates such as especially MDI.

R^{3c} is preferably a linear or branched alkylene radical having 1 to 6 C atoms, more particularly a radical selected from the group consisting of 1,3-propylene, 2-methyl-1,3-propylene, 1,4-butylene, 3-methyl-1,4-butylene, and 3,3-dimethyl-1,4-butylene, preferably 1,3-propylene and 3,3-dimethyl-1,4-butylene, more particularly 1,3-propylene. These hydroxysilanes are particularly readily available.

A preferred hydroxysilane of the formula (I c) is, in particular, selected from the group consisting of N-(3-triethoxysilylpropyl)-4-hydroxypentanamide, N-(3-triethoxysilylpropyl)-4-hydroxyoctanamide, N-(3-triethoxysilylpropyl)-4-hydroxynonanamide, N-(3-triethoxysilylpropyl)-4-hydroxydecanamide, N-(3-triethoxysilylpropyl)-4-hydroxyundecanamide, N-(3-triethoxysilylpropyl)-4-hydroxydodecanamide, N-(3-triethoxysilylpropyl)-5-hydroxyhexanamide, N-(3-triethoxysilylpropyl)-5-hydroxynonanamide, N-(3-triethoxysilylpropyl)-5-hydroxydecan amide, N-(3-triethoxysilylpropyl)-5-hydroxyundecanamide, N-(3-triethoxysilylpropyl)-5-hydroxydodecanamide, and the corresponding compounds having methoxy groups instead of ethoxy groups on the silane.

Preferred among these are N-(3-triethoxysilylpropyl)-4-hydroxypentanamide and N-(3-triethoxysilylpropyl)-4-hydroxyoctanamide.

With these hydroxysilanes, silane group-containing hotmelt adhesives with good storage stability are obtained which exhibit high thermal stability in the noncrosslinked state—even in the case of hotmelt adhesives based on aromatic isocyanates—and which cure rapidly with moisture to form crosslinked adhesives, and which exhibit good mechanical properties.

Particularly preferred in the method described are the hydroxysilanes of the formula (I a). These hydroxysilanes are particularly storage-stable, thereby simplifying their handling in the method described.

Most preferred in the method described are the hydroxysilanes of the formula (I c). They permit silane group-containing hotmelt adhesives based on aromatic isocyanates and having good thermal stability in the noncrosslinked state.

The silane group-containing hotmelt adhesive obtained by the method described may comprise further constituents, especially the following auxiliaries and adjuvants:
further crosslinkable polymers, especially polymers having silane groups and/or having isocyanate groups;
nonreactive thermoplastic polymers, especially homo- or copolymers of unsaturated monomers, more particularly from the group encompassing ethylene, propylene, butyl, isobutylene, isoprene, vinyl acetate, and alkyl (meth)acrylate, more particularly polyethylene (PE), polypropylene (PP), polyisobutylene, ethylene-vinyl acetate copolymers (EVA), and atactic poly-α-olefins (APAO); additionally polyesters, polyacrylates, polymethacrylates, polyacrylamides, polyacrylonitriles, polyimides, polyamides, polyvinyl chlorides, polysiloxanes, polyurethanes, polystyrenes, and combinations thereof, especially polyetheramide copolymers, styrene-butadiene-styrene copolymers, styrene-isoprene-styrene copolymers, styrene-ethylene-butylene-styrene copolymers, styrene-ethylene-propylene-styrene copolymers; and also, furthermore, butyl rubber, polyisobutylene, and combinations thereof, and also asphalt, bitumen, crude rubber, fluorinated rubber, and cellulose resins;
tackifier resins, especially a hydrocarbon resin such as, in particular, coumarone-indene resins, terpene resins, phenol-modified terpene resins, natural, optionally modified resins such as, in particular, rosin, tung resin or tall oil resin, and also α-methyl-styrene resins and polymeric lactic acid;
plasticizers, especially carboxylic esters such as phthalates or adipates, polyols, organic phosphoric and sulfonic esters, or polybutenes;
catalysts for the crosslinking reactions, especially metal catalysts and/or nitrogen-containing compounds, more particularly organotin compounds, organotitanates, amines, amidines, guanidines, and imidazoles;
stabilizers to counter oxidation, heat, hydrolysis, light, and UV radiation, biocides, fungicides, and flame retardants;
drying agents, especially tetraethoxysilane, vinyltrimethoxy- or vinyltriethoxy-silane, and organoalkoxysilanes, having a functional group in α-position to the silane group, more particularly N-(methyldimethoxysilylmethyl)-O-methyl carbamate, (methacryloyloxymethyl)silanes, methoxymethylsilanes, orthoformic esters, and also calcium oxide or molecular sieves;
adhesion promoters and/or crosslinkers, especially silanes such as aminosilanes, mercaptosilanes, epoxysilanes, (meth)acrylosilanes, anhydridosilanes, carbamatosilanes, alkylsilanes, and iminosilanes;
inorganic and organic fillers, especially mineral fillers, molecular sieves, silicas including finely divided silicas from pyrolysis processes, industrially manufactured carbon blacks, graphite, metal powders, PVC powders, or hollow beads;
dyes;
   and also further substances in common use in reactive hotmelt adhesives.

It may be advisable to carry out chemical or physical drying of certain constituents before adding them.

Such auxiliaries and adjuvants may be present even before the method described is carried out, especially as a constituent of the isocyanate group-containing polyurethane polymer which is solid at room temperature. Alternatively, such auxiliaries and adjuvants may not be added to the resulting silane group-containing hotmelt adhesive until after the method described has been carried out.

The method described results in a silane group-containing hotmelt adhesive. The silane group-containing hotmelt adhesive preferably comprises silane group-containing polyurethane polymer solid at room temperature in an amount in the range from 5 to 100 weight %, more particularly 15 to 95 weight %, very preferably 30 to 90 weight %, most preferably 50 to 80 weight %.

The silane group-containing hotmelt adhesive preferably comprises at least one further polymer selected from the group consisting of nonreactive thermoplastic polymers and tackifier resins.

The amount of polymers in the silane group-containing hotmelt adhesive, including the silane group-containing polyurethane polymer which is solid at room temperature, is preferably in the range from 70 to 100 weight %, more preferably 80 to 100 weight %, more particularly 90 to 100 weight %.

In one preferred embodiment, the silane group-containing hotmelt adhesive is free from organotin compounds. This may be advantageous on environmental and/or toxicological grounds.

In a further preferred embodiment, the silane group-containing hotmelt adhesive releases no methanol in the course of its crosslinking. This may be advantageous on environmental and/or toxicological grounds.

Where the method described has been carried out with a substoichiometric amount of hydroxysilane, the silane group-containing hotmelt adhesive comprises a polyurethane polymer containing both isocyanate groups and silane groups. A hotmelt adhesive of this kind comprises a significantly reduced level of monomeric isocyanates in comparison to before the method described is carried out. This is advantageous on toxicological grounds.

Where the method described has been carried out with an at least stoichiometric amount of hydroxysilane, the silane group-containing hotmelt adhesive is ultimately free from isocyanates. A hotmelt adhesive of this kind is particularly advantageous on toxicological grounds.

With exclusion of moisture, the silane group-containing hotmelt adhesive is very storage-stable. Before being used, it can be kept in a suitable pack or contrivance over a period ranging from several months up to a year or more. On contact with moisture, the silane groups undergo hydrolysis, leading ultimately to crosslinking of the adhesive. In this process, silanol groups may undergo condensation with, for example, hydroxyl groups of the substrate on which the adhesive is applied, and as a result of this, in the course of crosslinking, there may be additional improvement of the adhesion of the adhesive on the substrate. Where the hotmelt adhesive comprises isocyanate groups as well as the silane groups, the isocyanate groups likewise react with moisture, making an additional contribution to the crosslinking of the adhesive. The moisture needed for crosslinking may either come from the air (atmospheric humidity), or the adhesive may be contacted with a water-comprising component, by being coated or sprayed with such a component, for example.

On being employed, the silane group-containing hotmelt adhesive is applied in the liquid state to at least one substrate. For this purpose, the adhesive is initially heated at least to an extent that it is in liquid form. The adhesive is applied typically at a temperature in the range from 80 to 200° C., more particularly 100 to 180° C.

During processing, the noncrosslinked adhesive exhibits high thermal stability. This is evident from the fact that the adhesive can be left in the hot liquid state for a time sufficient for proper application, more particularly of up to several hours, without any undue increase in its viscosity, more particularly without gelling occurring, and without instances of odor pollution arising.

The applied adhesive is advantageously joined to a second substrate to give an adhesive bond, before it has excessively solidified as a result of cooling. Alternatively, it can solidify in the applied state and at a later point in time be melted again and joined to a second substrate to form an adhesive bond. In that case it is necessary to ensure that the renewed melting of the adhesive takes place before the crosslinking of its reactive groups disrupts the melting process. For this purpose it may be advantageous to protect the applied adhesive from ingress of moisture prior to solidification, in particular by covering it with a protective film.

The solidification of the adhesive as a result of cooling brings about a very rapid development of strength and a high initial strength of adhesion of the bond. In addition to this physical adhesive curing, there is also crosslinking via silane groups and optionally isocyanate groups by moisture in the adhesive, after the solidification, as described earlier. This chemical crosslinking leads ultimately to a fully cured, crosslinked adhesive, which cannot be melted again by reheating to the application temperature.

Preferred substrates which can be bonded using the silane group-containing hotmelt adhesive from the method described are
glass, glass-ceramic, concrete, mortar, brick, tile, plaster, and natural stone such as granite or marble;
metals and alloys, such as aluminum, iron, steel, and nonferrous metals, and also surface-enhanced metals and alloys, such as galvanized or chromed metals;
leather, textile, paper, wood, woodbase materials bonded with resins, such as with phenolic, melamine or epoxy resins, resin-textile composites, and other so-called polymer composites;
plastics, such as polyvinyl chloride (rigid and flexible PVC), acrylonitrile-butadiene-styrene copolymers (ABS), polycarbonate (PC), polyamide (PA), polyesters, poly(methyl methacrylate) (PMMA), epoxy resins, polyurethanes (PU), polyoxymethylene (POM), polyolefins (PO), polyethylene (PE) or polypropylene (PP), ethylene/propylene copolymers (EPM) and ethylene/propylene/diene terpolymers (EPDM), and also fiber-reinforced plastics such as carbon fiber-reinforced plastics (CRP), glass fiber-reinforced plastics (GRP), and sheet molding compounds (SMC), it being possible for the plastics to have been surface-treated preferably by means of plasma, corona, or flaming;
coated substrates, such as powder-coated metals or alloys;
paints and coatings, more particularly automotive topcoats.

Particularly preferred among these are plastics, textiles, leather, wood, woodbase materials, polymer composites, paper, metals, paints and coatings. The substrates may be pretreated before the adhesive is applied, by means for example of physical and/or chemical cleaning, or by the application of an adhesion promoter, an adhesion promoter solution, or a primer.

Bonding may be between two similar substrates or two different substrates. Either the adhesive is applied to one of the two substrates and joined to the other to form a bond, or it may be applied to both of the substrates to be bonded.

Preference is given to the bonding of two different substrates.

The silane group-containing hotmelt adhesive from the method described can be used in particular for construction and industrial applications, more particularly as laminating adhesive, laminate adhesive, packaging adhesive, textile adhesive, or wood adhesive. It is particularly suitable for bonds in which the bonding location is visible, more particularly for the bonding of glass, in vehicle and window construction, for example, and also for the bonding of transparent packaging.

The use of the silane group-containing hotmelt adhesive from the method described results in an article.

Preferred articles are automotive interior equipment components such as, in particular, roof linings, sun visors, instrument panels, door side parts, parcel shelves, and the like, wood fiber materials from the bath and shower sector, decorative furniture foils, membrane films with textiles such as, in particular, cotton, polyester films in the clothing sector, composites of textiles and foams for automotive equipment, and transparent packaging.

The silane group-containing hotmelt adhesive obtained from the method described has a series of advantages.

It permits a low hazard classification, since depending on the stoichiometry employed it contains little or no monomeric isocyanates. Before being used, it can be stored in a suitable moisture tight container over a period ranging from several months to a year, without detraction from its good application facility. On heating to a temperature in the range from 80 to 200° C., more particularly 100 to 180° C., it has a viscosity at which it is easily applied, and in the hot liquid state it is highly stable, in contrast to aminosilane-based and mercaptosilane-based, silane group-containing hotmelt adhesives from the prior art, which tend toward severe increases in viscosity to the point of gelling, or to instances of odor nuisance.

At room temperature under the influence of moisture, the adhesive crosslinks without blisters and leads to an optically and mechanically high-grade adhesively bonded assembly with excellent adhesion and high resistance to environmental influences.

### EXAMPLES

Set out below are working examples which are intended to elucidate the above-described invention in more detail. The invention is of course not confined to these working examples described.

“Standard conditions” refers to a temperature of 23±1° C. and a relative atmospheric humidity of 50±5%.

Viscosities were determined on a thermostated plate/plate viscometer, Rheotec RC30 (plate diameter 25 mm, distance 1 mm, shear rate 10 s⁻¹) at a temperature of 160° C.

### 1. Preparation of Polyurethane Polymer Containing Isocyanate Groups

### Polymer P1

A mixture of 1200.0 g of amorphous polyester diol solid at room temperature (Dynacoll® 7150 from Evonik; OH number 43 mg KOH/g) and 1200.0 g of polyester diol liquid at room temperature (Dynacoll® 7250 from Evonik; OH number 22 mg KOH/g) was dried and degassed under reduced pressure at 120° C. for 2 hours, then admixed with 348.4 g of 4,4′-methylenediphenyl diisocyanate (Desmodur® 44 MC L from Bayer), stirred under reduced pressure at 130° C. for 2 hours, and subsequently cooled and stored in the absence of moisture. The resulting polyurethane polymer was solid at room temperature and had a free isocyanate group content of 2.15 weight %.

### 2. Preparation of Hydroxysilane

Hydroxysilane S-1: N-(3-Triethoxysilylpropyl)-4-hydroxypentanamide In a round-bottom flask, 100.0 g (452 mmol) of 3-aminopropyltriethoxysilane and 54.3 g (542 mmol) of γ-valerolactone were stirred under a nitrogen atmosphere at 140° C. for about 8 hours until progress of reaction was no longer ascertained using IR. The crude product was aftertreated at 80° C. and about 2 mbar for 30 minutes. This gave a liquid product having a theoretical OH equivalent weight of 321.5 g.

### 3. Reaction of the Polyurethane Polymer Containing Isocyanate Groups

### Example 1

### Hotmelt Adhesive K-1

A mixture of 200.0 g (about 102.4 mmol NCO) of melted polymer P1 and 36.2 g (about 112.6 mmol) of hydroxysilane S-1 was stirred under nitrogen at 120° C. for 2 hours until isocyanate was no longer detectable by IR spectroscopy. Then 40 mg of dibutyltin dilaurate were added and the resulting polymer containing silane groups was cooled and stored in the absence of moisture.

The hotmelt adhesive K-1 is free from isocyanate groups.

### Example 2

### Hotmelt Adhesive K-2

A mixture of 200.0 g (about 102.4 mmol NCO) of melted polymer P1 and 16.45 g (about 51.2 mmol) of hydroxysilane S-1 was stirred under nitrogen at 120° C. for 2 hours until the isocyanate band showed no further decrease by IR spectroscopy. Then 40 mg of dibutyltin dilaurate were added and the resulting polymer containing silane groups was cooled and stored in the absence of moisture.

The hotmelt adhesive K-2 comprises isocyanate groups as well as the silane groups.

### Comparative Example 1

### Hotmelt Adhesive Ref-1

A mixture of 200.0 g (about 102.4 mmol NCO) of melted polymer P1 and 26.85 g (about 112.6 mmol) of 3-mercaptopropyltriethoxysilane were stirred under nitrogen at 120° C. for 2 hours until the isocyanate band no longer showed any further decrease by IR spectroscopy. Then 40 mg of dibutyltin dilaurate were added and the resulting polymer containing silane groups was cooled and stored in the absence of moisture.

The silane group-containing hotmelt adhesive Ref-1 was obtained from comparative example 1. It was observed that this adhesive smells only slightly of mercaptosilane at room temperature and is free from isocyanate groups according to IR spectroscopy. In the melted state at 120° C., a very strong odor of mercaptosilane is perceptible, and IR spectroscopy indicates that isocyanate groups are present again. This is an indication that the thermal stability of the thiourethane bond is so low that some of the mercaptosilane is released under the hot conditions.

### Comparative Example 2

### Hotmelt Adhesive Ref-2

200.0 g (about 102.4 mmol NCO) of melted polymer P1 were admixed at 120° C. with 25.0 g (about 112.9 mmol) of 3-aminopropyltriethoxysilane (Dynasylan® AMEO from Evonik) and the mixture was stirred under nitrogen. The mixture gelled during the preparation.

### 4. Properties of the Resulting Hotmelt Adhesives

### Monomeric 4,4′-methylenediphenyl diisocyanate content

The monomeric isocyanate content was determined by HPLC.

The polymer P1 contained 2.60 weight % of 4,4′-methylenediphenyl diisocyanate.

The hotmelt adhesive K-2 contained 0.63 weight % of 4,4′-methylenediphenyl diisocyanate, in other words a significantly reduced amount.

### Thermal Stability in the Noncrosslinked State:

A number of aluminum tubes were filled with freshly prepared, melted hotmelt adhesive and sealed and then stored in a forced air oven at 160° C. The viscosity was determined in each case on the fresh material (“0 h”) and after 2 h, 4 h, and 6 h of storage at 160° C. The results are reported in table 1.

TABLE 1
Viscosity of inventive hotmelt adhesives K-1
and K-2 and of comparative adhesive Ref-1.

| Hotmelt adhesive | | K-1 | K-2 | Ref-1 |
|---|---|---|---|---|
| Viscosity | after 0 h | 99 | 84 | 19.5 |
| (160° C.) | after 2 h | 97 | 106 | 16.7 |
| | after 4 h | 139 | 303 | 17.3 |
| | after 6 h | 148 | gelled | 17.3 |

| | | | |
|---|---|---|---|
| Odor | none | none | severe |

### Mechanical Properties:

For the determination of the mechanical properties, the respective hotmelt adhesive was pressed to a film with a thickness of 1 mm between two PTFE-coated sheets in a heatable press, and the film was cooled, the PTFE-coated sheets were removed, and dumbbell-shaped test specimens with a length of 75 mm, a crosspiece length of 30 mm and a crosspiece width of 4 mm were punched from the film. For each hotmelt adhesive, three test specimens were measured 3 h after manufacture (identified as “fresh” in table 2), and three further specimens were measured after storage under standard conditions for 10 days (identified in the table as “10d SC”). Determinations were made of tensile strength (force at break), elongation at break, and elasticity modulus (within the stated elongation range) in accordance with DIN EN 53504 at a tensioning speed of 200 mm/min. The results are reported in table 2.

TABLE 2
Mechanical properties of inventive hotmelt
adhesives K-1 and K-2 and of polymer P1.

| Hotmelt adhesive | | K-1 | K-2 | Polymer P1 |
|---|---|---|---|---|
| fresh: | tensile strength [MPa] | 1.44 | 2.21 | 0.11 |
| | elongation at break [%] | 1960 | 1040 | 60 |
| | elast. modulus (0.5-5%) [MPa] | 2.74 | 3.19 | 0.82 |
| | elast. modulus (0.5-25%) [MPa] | 1.15 | 1.41 | 0.20 |
| | elast. modulus (0.5-50%) [MPa] | 0.63 | 0.81 | 0.04 |
| | appearance | clear | clear | clear |
| 10 d | tensile strength [MPa] | 5.64 | 9.56 | 10.40 |
| SC: | elongation at break [%] | 960 | 580 | 460 |
| | elast. modulus (0.5-5%) [MPa] | 3.00 | 4.92 | 6.90 |
| | elast. modulus (0.5-25%) [MPa] | 1.42 | 2.57 | 3.55 |
| | elast. modulus (0.5-50%) [MPa] | 0.87 | 1.70 | 2.37 |
| | appearance | no | few | few |
| | | blisters | small | large |
| | | | blisters | blisters |

1. A method for producing a silane group-containing hotmelt adhesive by reacting at least one isocyanate group-containing polyurethane polymer which is solid at room temperature with at least one hydroxysilane which is free from urea groups and from thiourethane groups.

2. The method as claimed in claim 1, wherein the OH groups of the hydroxysilane are present substoichiometrically in relation to the isocyanate groups of the polyurethane polymer, and the hotmelt adhesive obtained has a monomeric isocyanate content of <2 weight %.

3. The method as claimed in claim 1, wherein the OH groups of the hydroxysilane are present at least stoichiometrically in relation to the isocyanate groups of the polyurethane polymer, and the hotmelt adhesive obtained therefrom is free from isocyanates.

4. The method as claimed in claim 1, wherein the isocyanate group-containing polyurethane polymer has an average molecular weight Mₙ in the range from 2000 to 20,000 g/mol.

5. The method as claimed in claim 1, wherein the isocyanate group-containing polyurethane polymer has 1 to 3 isocyanate groups per molecule.

6. The method as claimed in claim 1, wherein the isocyanate group-containing polyurethane polymer has been prepared using a mixture of at least one amorphous polyester diol and at least one further polyester diol.

7. The method as claimed in claim 1, wherein the isocyanate group-containing polyurethane polymer has been prepared using a diisocyanate selected from the group consisting of 1-isocyanato-3,3,5-trimethyl-5-isocyanatomethylcyclohexane (IPDI), 4,4′-, 2,4′-, and 2,2′-diphenylmethane diisocyanate and any mixtures of these isomers (MDI), and 2,4- and 2,6-tolylene diisocyanate and any mixtures of these isomers (TDI).

8. The method as claimed in claim 1, wherein the hydroxysilane comprises a secondary hydroxyl group.

9. The method as claimed in claim 8, wherein the hydroxysilane represents a hydroxysilane of the formula (I), 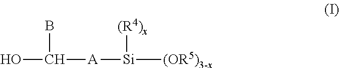
where
A either is a divalent aliphatic or cycloaliphatic hydrocarbon radical having 2 to 30 C atoms, optionally with aromatic fractions and optionally with one or more heteroatoms, which is free from active hydrogen,
or together with B—CH is a divalent cycloaliphatic hydrocarbon radical having 6 to 20 C atoms, optionally with aromatic fractions and optionally with one or more heteroatoms, which is free from active hydrogen;
B is a monovalent aliphatic or cycloaliphatic hydrocarbon radical having 1 to 12 C atoms, optionally with one or more heteroatoms, which is free from active hydrogen, or together with CH-A is a divalent cycloaliphatic hydrocarbon radical having 6 to 20 C atoms, optionally with one or more heteroatoms, which is free from active hydrogen;
R⁴ is an alkyl group having 1 to 8 C atoms;
R⁵ is an alkyl group having 1 to 10 C atoms, optionally with one or more ether oxygens; and
x is 0 or 1 or 2.

10. The method as claimed in claim 8, wherein the hydroxysilane represents a hydroxysilane of the formula (I a), 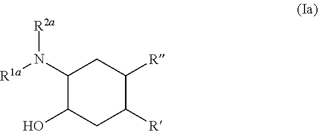
where
either R′ is a radical of the formula (II) and R″ is hydrogen
or R′ is hydrogen and R″ is a radical of the formula (II); 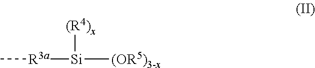
R^{1a} and R^{2a} either individually are each an alkyl radical having 1 to 12 C atoms, which optionally has heteroatoms in the form of ether oxygen, thioether sulfur, or tertiary amine nitrogen,
or together are an alkylene radical having 2 to 12 C atoms which optionally has heteroatoms in the form of ether oxygen, thioether sulfur, or tertiary amine nitrogen;
R^{3a} is a linear or branched alkylene or cycloalkylene radical having 1 to 20 C atoms, optionally with aromatic fractions, and optionally with one or more heteroatoms.

11. The method as claimed in claim 8, wherein the hydroxysilane represents a hydroxysilane of the formula (I b), 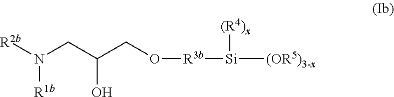
where R^{1b} and R^{2b} either individually are each an alkyl radical having 1 to 12 C atoms, which optionally has heteroatoms in the form of ether oxygen, thioether sulfur, or tertiary amine nitrogen,
or together are an alkylene radical having 2 to 12 C atoms which optionally has heteroatoms in the form of ether oxygen, thioether sulfur, or tertiary amine nitrogen;
R^{3b} is a linear or branched alkylene or cycloalkylene radical having 1 to 20 C atoms, optionally with aromatic fractions, and optionally with one or more heteroatoms.

12. The method as claimed in claim 8, wherein the hydroxysilane represents a hydroxysilane of the formula (I c), 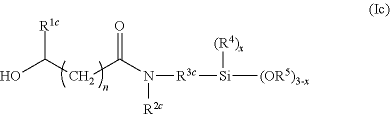
where
R^{1c} is an alkyl group having 1 to 12 C atoms;
R^{2c} is a hydrogen atom or is an alkyl group having 1 to 12 C atoms which optionally has ether oxygen or amine nitrogen;
R^{3c} is a linear or branched alkylene or cycloalkylene radical having 1 to 20 C atoms, optionally with aromatic fractions, and optionally with one or more heteroatoms; and
n is 2 or 3 or 4.

13. A silane group-containing hotmelt adhesive wherein it has been obtained from a method as claimed in claim 1.

14. The silane group-containing hotmelt adhesive as claimed in claim 13 is implemented in at least one of laminating adhesive, laminate adhesive, packaging adhesive, textile adhesive, or wood adhesive.

15. An article obtained from the implementation claimed in claim 14.
